(19) United States
(12) Patent Application Publication
(10) Pub. No.: US 2002/0129861 A1
(43) Pub. Date: Sep. 19, 2002

(54) Washing machine hose

(76) Inventor: Howard J. Holdenried, Sioux City, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 10/097,517

(22) Filed: Mar. 13, 2002

Related U.S. Application Data
(60) Provisional application No. 60/275,657, filed on Mar. 14, 2001.

(51) Int. Cl. D06F 39/08; F16L 11/00

(52) U.S. Cl. 138/109; 68/207; 138/120

(57) ABSTRACT

The invention is an improved washing machine and hose for a washing machine, which helps prevent water damage to homes or businesses. The fitting can comprise of a modified male coupling of the type used with PEX tubing and fittings in combination with a modified threaded female garden hose end. A washer could optionally be placed inside the fitting for improved watertight seal. The modified coupling is installed inside the end of a PEX tubing, and in combination with an adjustable PEX ring, forms a very strong sealed joint between the coupling and the tubing.

### BACKGROUND OF THE INVENTION

1. Field of the Invention

The present invention relates to washing machines, and more specifically, to the hoses and fittings linking the washing machine to its water supply.

2. Problems in the Art

Water damage from leaking or burst washing machine water hoses is a significant cause of home damage. Unless turned off after every use of the washing machine, pressurized water is present all the way to the internal valving of the washing machine. Most persons do not choose to turn off the water supply to the machine when not in use, or when they are gone from the home. Additionally, people will often start a load of laundry before leaving for work or possibly leaving for a weekend. This puts substantial stress and strain on the hoses.

Frequently, and especially over time, conventional water hoses for washing machines burst, separate from their fittings, or leak, and water escapes. At a minimum, such events require substantial clean-up effort, but many times cause damage to the home or items in the home. By the time the person notices the problem or returns home after being absent, the house or a part of it has been flooded creating a major disaster.

Some estimate that broken washing machine hoses alone destroy $150 million in property each year. This is a significant concern for homeowners and insurance companies. Similar problems exist wherever conventional consumer washing machines are installed, including in non-residential settings.

Reasons for hose breakage can include a weak, weakened, or failed hose, or a connection or part thereof between a hose and the fitting. Traditional washing machine hoses for conventional consumer washing machines are garden hoses or similar thereto, including a metal or plastic male and female threaded connection to which an end of a rubber or synthetic hose is clamped or otherwise secured. If this joint is not durable or is inherently weak or defective, it can separate, especially since the hose between the water source and washing machine is under pressure.

The hoses and fittings (like conventional consumer garden hose fittings) are made of relatively inexpensive materials and are relatively low cost. It is believed that to minimize cost and provide a widely available source of such hoses, these types of hoses are used for washing machine water connections, leaving the risk and burden on the washing machine/homeowner relative to whether the hose fails or does not fail in some way. Some washing machine manufactures and consumer publications actually warn consumers of such washing machines to automatically periodically replace the hoses to reduce the chance of a problem, or at least frequently check them. Some even suggest turning off the water supply to the washing machine hoses every time one leaves the house. It is believed few people follow these suggestions routinely.

The conduits used in residential and commercial buildings to carry water from the water main or other water source to fixtures within the building are traditionally copper or plastic pipe. Given its function; to hold and carry pressurized water for a reasonable period of time (at least on the order of several decades), such conduits must have a degree of strength and durability. Such plumbing must also be safe to carry potable water. Any fittings or junctions must be very secure and durable. However, such conduits are usually fixed in place and are concealed or at least somewhat shielded, and thus are not likely to experience substantial forces other than the water pressure therethrough. They are not periodically adjusted or moved.

Copper pipe has traditionally functioned well for this. It is not as strong as some other metals, but resists corrosion in the presence of water. Its wall thickness can be quite thin to perform adequately. If copper pipe were exposed to bending or pulling or blunt forces such as with washing machine hoses (including when a washing machine is moved or adjusted in position after installation and/or the hoses are disconnected or reconnected), it may not work adequately or may fail.

Copper piping is relatively expensive. Over the past several decades, a variety plastic or synthetic materials have been developed as an alternative. One such alternative is cross-linked polyethylene tubing, sometimes referred to as PEX tubing, available from a variety of manufacturers. One example is AQUAPEX® from Wirsbo Company of Apple Valley, Minn. It has some flexibility compared to copper and is non-toxic and will not corrode, pit, or scale. Many plumbing codes have approved it for hot and cold potable water service and distribution.

At least some types of PEX tubing (e.g. AQUAPEX® type tubing) has shape memory in the sense that if expanded, one the expansion force is released, it will contract back to substantially original shape. As is known, this type of material allows for appropriate sized fittings to be to be seated into an expanded end of the tubing and then held in place by the contracting forces once the shape-memory effect contracts the tubing back to original shape. There are some types of PEX or similar materials that may not have such substantial shape memory or contracting forces.

As stated above, not only is a relatively durable tubing needed for plumbing of this nature, but the connections and fittings must be very reliable. In fact, for the reasons stated above, the fittings must be generally more robust than the conduit. With copper conduit, connection can be made by soldering the joints, including connections to faucets or valves. Done properly, this usually provides a good seal. However, joints for PEX tubing can not be sealed in this manner. Fittings or joints for some PEX materials can be sealed and secured with shape memory effect and contracting forces. For other PEX type materials, clamps, crimping, and other methods can be used. Therefore, a number of types of fittings and methods of connection have been developed for PEX tubing to attain approval. The required durability and reliability means that most of the these fittings are relatively expensive, when compared to the types of fittings used with conventional garden hose applications.

Also, special training is needed to learn how to handle PEX tubing and related hardware, and in particular, to make good joints, connections, and fitting installations. There are sometimes special tools involved, especially for shape memory. For example, expansion tools cost at least several hundred dollars.

Still further, while PEX tubing is somewhat flexible, it is not totally flexible like rubber hoses. It can kink if bent to a certain degree.

There are fittings available to connect pieces of PEX tubing. Some are brass. Also, fittings exist to connect PEX tubing to copper tubing. This may include a reduction or expansion to a male or female threaded end, including swivel connectors (e.g. Aquapex® ProPex® brass swivel faucet adapter).

Thus, these types of plumbing conduits and fittings have not been viewed as practical or applicable outside of that environment. It is not believed that fittings are even normally created to interface these conduits to garden hose type spigots.

It is therefore a primary objective of the present invention to improve over the state of the art.

Further objects, features or advantages of the present invention are to provide a washing machine hose where:

water damage to homes and businesses are significantly reduced or eliminated;

the hose fitting and junction to a hose is significantly stronger, more durable, and less likely to leak, crack, break, burst, or separate;

the fitting and the hose are connected in a way to prevent leakage or bursting where the hose and fitting interconnect;

the hose and fittings are durable, relatively economical, and easy to install and use.

These and other objects, features, and advantages of the present invention will become apparent with reference to the accompanying specification.

### SUMMARY OF THE INVENTION

The invention is an improved washing machine and conduit between a water source and a conventional household type washing machine, which helps prevent water damage to homes or businesses. The conduit comprises of a modified Wirsbo™ type, or equivalent or similar type, male coupling combined with a standard garden hose threaded female coupling or equivalent or similar type, which is adaptable to standard water source and washing machine water connections. A sealing washer can be placed inside the female coupling. An extension of the modified male coupling is inserted inside the end of a PEX tubing or equivalent or similar tubing. An adjustable PEX ring, or equivalent or similar ring or sleeve, can also be located outside the opening of the tubing. The tubing or the tubing and sleeve, having shape memory characteristics, pinch or compress down on the male coupling thus providing for a very strong seal between the coupling and the tubing. The tubing preferably is a high strength cross-linked polyethylene or PEX tubing, such as AQUAPEX® (Engel method PEX) manufactured by Wirsbo™.

### BRIEF DESCRIPTION OF THE DRAWINGS

FIG. 1 is an isometric view of the hose and fittings according to an embodiment of the present invention, with a fitting assembly at one end of the hose shown in exploded form.

FIG. 2 is a cross sectional view taken along line 2-2 of FIG. l.

FIG. 3 is a perspective view of the hose and fittings of FIG. 1 connected between hot and cold water inlets to a conventional consumer washing machine and hot and cold water supply sources, with one hose shown detached and one hose attached.

FIG. 4 is a side elevational view of an alternative embodiment of male coupling 32 of FIGS. 1 and 2.

### DETAILED DESCRIPTION OF THE PREFERRED EMBODIMENT

To assist in a better understanding of the invention, a preferred embodiment of the invention will now be described in detail. It is to be understood that this is but one form the invention can take and is for purposes of illustration and not limitation.

To assist in this description, reference will be taken to the appended drawings, which are incorporated by reference herein in their entirety. Reference numerals are used in this description to indicate certain parts and locations in the drawings. The same reference numerals will be used to indicate the same parts and locations throughout the drawings unless otherwise indicated.

Structure

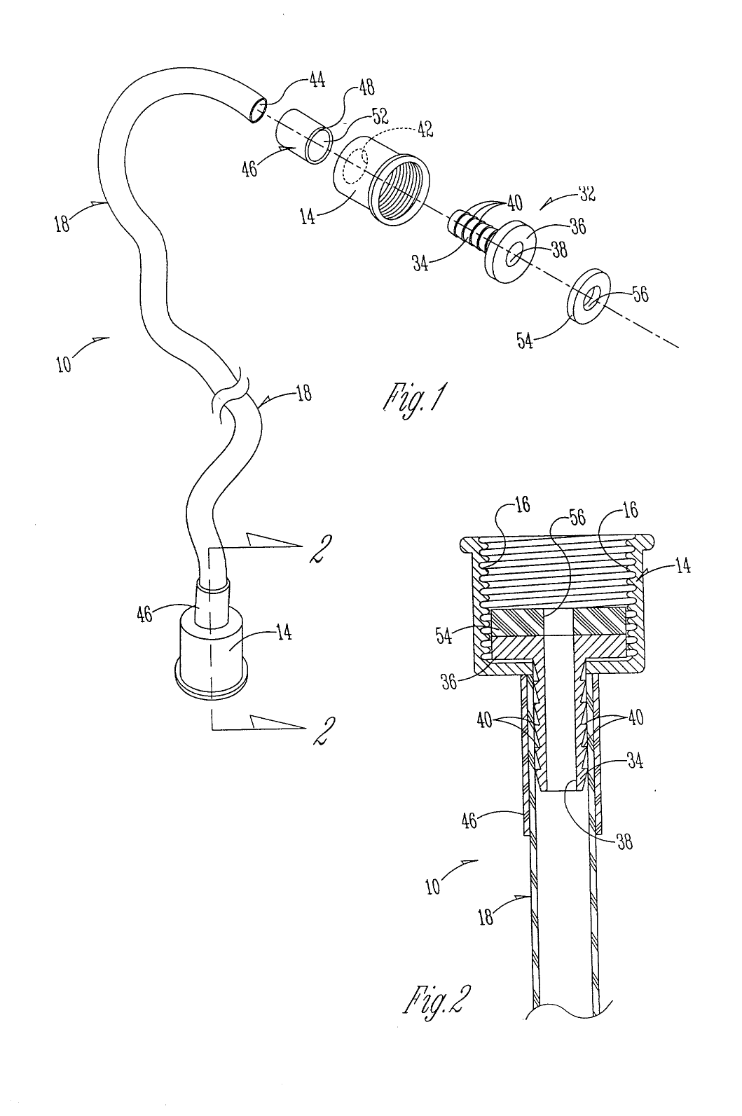

FIGS. 1-3 illustrate improved washing machine hoses, indicated generally at reference numeral 10. Each hose 10 includes a connection or fitting at each end, indicated generally at reference numeral 12.

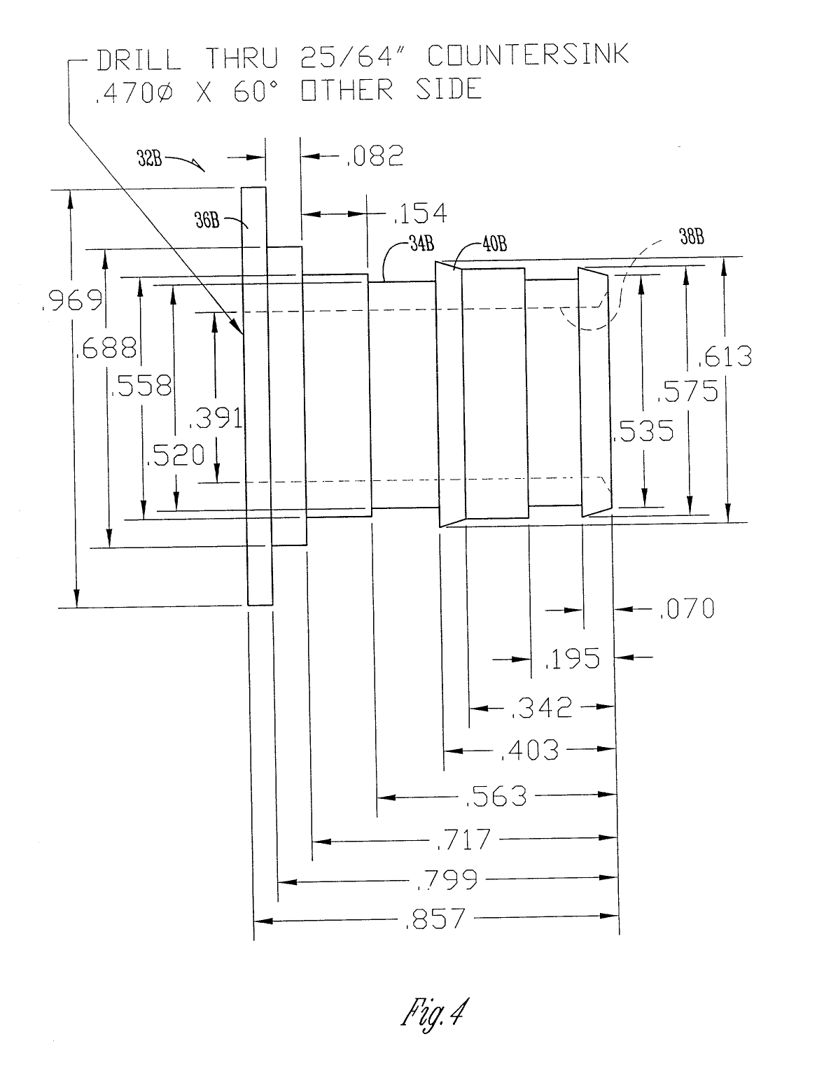

FIG. 3 illustrates connection of two hoses 10 between a pressurized water source, shown diagrammatically at reference numeral 30. The pressurized water source can be from a water main supplied by a municipality or any other water source capable of delivery of water to a washing machine. It is to be understood that the water source can include heated or hot water, normally via a conventional residential hot water heater (not shown), as well as unheated or cold water, normally bypassing a water heater.

Hot and cold water are normally presented at the location of a washing machine by hot and cold water spigots 26 and 28 including male threaded ends and manually operable on/off valves. Conventional consumer washing machines normally have hot and cold male threaded inlets 22 and 24. The configuration and size of male threaded members 22, 24, 26, and 28, at least in the United States, usually threadably mate with female threaded receivers identical to conventional garden hoses and spigots. This is believed to be called ¾ inch hose threads.

Thus, as illustrated at FIG. 3, hoses 10, having female threaded ¾ inch swivel hose thread receivers 14 at each end, can be manually threadable secured between a respective male threaded ¾ inch thread water source spigot and a male threaded ¾ inch thread washing machine inlet. This connects hot and cold water to washing machine 20.

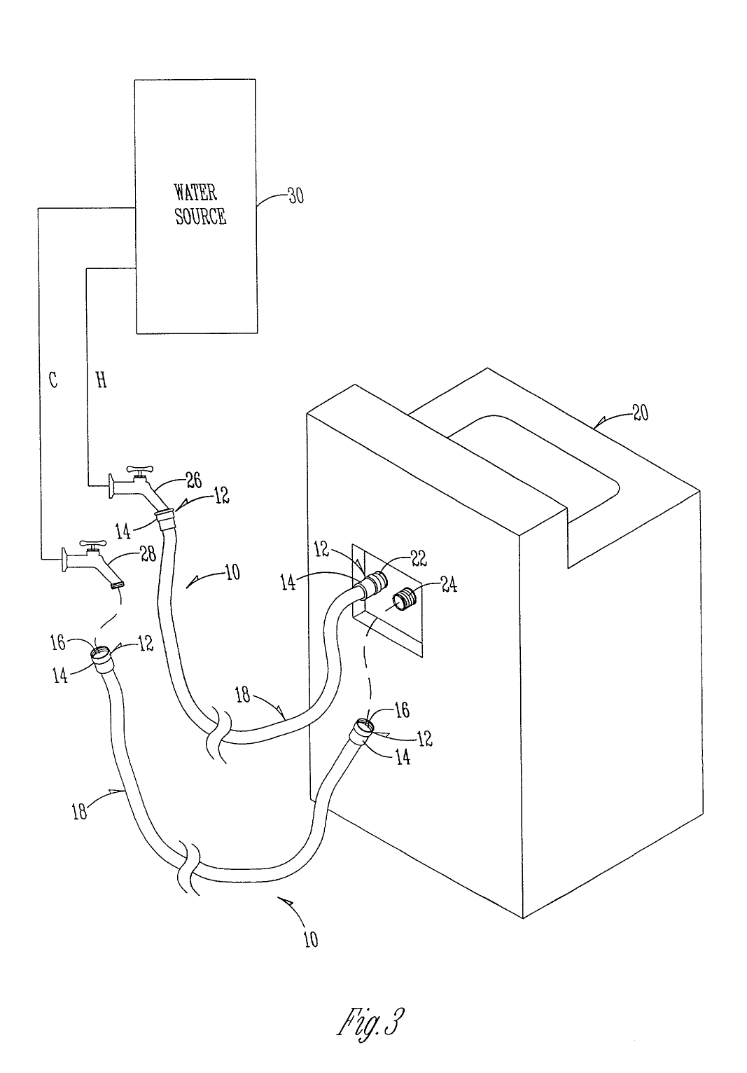

FIGS. 1 and 2 illustrate in detail the structure of each fitting 12. All fittings 10 shown are identical in structure, so only one will be described herein for brevity.

Tubing 18 is a AQUAPEX® cross-linked polyethylene (PEX) ½ inch hose 22 (available from Wirsbo Company). A modified Wirsbo™ male coupling 32 has an elongated section 34 (approx. 9/16 inch outside diameter) and a larger head 36 (approx. ⅞ inch outside diameter). An approx. 7/16 inch diameter internal bore extends through coupling 32. External ridges extend laterally from section 34 (see particularly FIG. 2).

Coupling 32 was made by buying an off-the-shelve Wirsbo™ plug (e.g. ProPEX brass PEX plug from Wirsbo Company), identical to coupling 32 shown in FIGS. 1 and 2 except that internal bore 38 is blocked at head 36. The distal part of head 36 of such a plug was cut off to expose bore 38 or, if the plug is solid, bore 38 is drilled longitudinally through the plug. Thus, a passageway entirely through member 32 was created.

A standard brass female ¾ inch thread garden hose end (approx. 1⅛ inch outside diameter) was cut off a standard garden hose to create threaded female receiver 14. Opening 42 in receiver 14 is approx. ⅝ inch diameter.

A ½″ cross-linked polyethylene (PEX) ring or sleeve 46 having opposite open ends 48 and 50 and a passageway 52 therebetween is slid over the end of tubing section 18. End 34 of coupling 32, being slightly smaller in outside diameter than opening 42 in receiver 14, is inserted through the interior of receiver 14 and through opening 42, until seated into receiver 14. Opening 42 is smaller than head 36, which presents a stop relative to how far coupling 32 can be seated into receiver 14 (see FIG. 2).

End 52 of sleeve 46 is approximately aligned with end 44 of tubing 18, and then, as is known relative to use of PEX tubing, a special expansion tool (not shown) is inserted into end 44 of tubing 18. The tool radially expands end 44 and sleeve 46. The nature of PEX material is that it will expand for a short time in response to the tool. Quickly, one inserts end 32 of the assembled coupling/receiver combination 32/14 into expanded end 44 of tubing 18. In a matter of a few seconds later, the memory characteristic of the PEX material will return tubing 18 to its original, normal size. The co-action of both end 44 and sleeve 46 around it, will thus essentially contract or compress around and over end 32 to create a secure coupling of receiver 14 to tubing 18. Raised ridges 40 will essentially bite into the inside of tubing 18 and assist in securing the joint, and resist longitudinal separation of coupling 32 and tubing 18.

As is well known, this connection, such as available with the Wirsbo Company AQUAPEX tubing and Wirsbo Company PROPEX fittings and tool, create a permanent, leak proof, and reliable connection that meets such standards as ASTM Standard F877 and are CAN/CSA (B137.5) approved for use in potable water distribution systems.

FIG. 2 shows the final assembly. A 1-inch outside diameter, 9/16 inch inside diameter washer can be inserted into receiver 14 and positioned against head 36 of coupling 32. As shown, the modified coupling presents a standard ¾ inch garden hose thread female receiver with a secure connection to tubing 18 and is available for threading onto either a water source spigot 26 or 28, or a washing machine inlet 22 or 24. Receiver 14 can rotate about its longitudinal axis, to make it easier to thread onto member 26, 28, 22, or 24, but is held against longitudinal movement relative to tubing 18 by coupling 32 and the properties of tubing 18 and sleeve 46.

Operation

With reference to FIG. 2, one end of an improved washing machine hose and fitting 10 is shown fully assembled. The same assembly could be accomplished at the opposite end of tubing 18.

Tubing 18, with fittings 12 at both ends could be connected between washing machine 20 and water source 30 just like conventional washing machine hoses. But instead of the risk and frailties of conventional garden hoses and fittings, the much stronger and durable PEX tubing is in place (e.g. AQUAPEX is chemically resistant, and able to withstand relatively extreme temperatures and pressures).

The joint or connection between fittings 12 and tubing 18, if correctly assembled, have been proven very strong, durable and reliable.

In FIG. 3 an improved washing machine hose and fitting 10 is shown connecting a washing machine 26 to a water supply (via a standard faucet 28). The improved washing machine hose and fitting 10 will help prevent home and business water damage. Water hoses bursting will be reduced because improved washing machine hose and fitting 10 uses PEX tubing 18. PEX tubing 18 is a very strong tubing rated at 73.4° F. at 160 psi, 180° F. at 100 psi and 200° F. at 80 psi. PEX tubing 18 is typically guaranteed to last over 25 years. Further, PEX tubing 18 is flexible, corrosion resistant and freeze resistant. In the preferred embodiment PEX tube 22 is ½ in diameter, however, PEX tubing can be ⅜″, ⅝″, ¾″, 1″, 1¼″ and 1½″. Other sizes, manufacturers and configurations are available and possible.

Additionally, any leaking or bursting that typically occurs where the fitting joins with the tubing will be reduced by improved washing machine hose and fitting 10. By utilizing ½″ PEX ring 46 and PEX tubing 18 and the shape memory pinching action against elongated section 32, the possibilities of leaking or bursting at the fitting are greatly reduced. The shape memory of AQUAPEX® creates a simple, inexpensive and incredibly strong connection and has been tested to be stronger than the tube itself. Due to the compression of the PEX ring 46 and PEX tube 18, the fitting connection is now substantially permanent, leak proof, and reliable.

Options and Alternatives

The description above is but one form the invention can take, and is given by way of illustration and example only, and not be way of limitation. Variations obvious to those skilled in the art are included within the scope of the invention.

For example, the precise sizes of certain of the components can vary according to need and desire. The size of tubing and openings should be sufficient for the functions of the washing machine.

Coupling 32 and receiver 42 ideally would be mass produced instead of being hand fabricated.

Other elements can be added to the couplings. For example, a brass or other type of material washer or spacer could be added inside female receiver 14 to take up any play.

AQUAPEX, and it is believed other PEX materials, has thermal memory. Therefore, if the tubing is kinked in any way, the tubing can be heated at that location and the kink can be removed.

A specific alternative embodiment for coupling 32 is shown in FIG. 4, referenced generally as coupling 32B. This coupling can be originally manufactured, preferably from brass (for example, by a computer-controlled metal machining tool). As can be seen, coupling 32B has a head 36B, an internal bore 38B and a section 34B. A raised ridge 40B assists in biting into the Wirsbo or PEX hose 22 to assist in retaining coupling 32B in place. FIG. 4 shows the precise dimensions according to one embodiment for coupling 32B for use with ½″ tubing (e.g. AQUAPEX®). Appropriate modified dimensions would be made for use with other sized tubing, such as would be within the skill of those skilled in the art. It would be assembled with the other components shown in FIG. 1 as a substitute for coupling 32 shown in FIGS. 1 and 2.

As used herein, the term “PEX” refers generally to cross-linked polyethylene, either shape memory or not. The invention is believed applicable to similar analogous materials having similar properties.

1. An apparatus for connecting a water supply to a washing machine comprising:
(a) a length of cross-linked polyethylene (PEX) conduit having opposite open ends;
(b) a fitting in at least one opposite end of the conduit, the fitting comprising a female garden hose threaded swivel connection.

2. The apparatus of claim 1 further comprising a second PEX conduit and fitting according to claim 1, said PEX conduit and fitting and said second PEX conduit and fitting adapted for connection between hot and cold water source connections and hot and cold water inputs to a washing machine.

3. The apparatus of claim 1 wherein the length of the PEX conduit is no longer than 6 feet.

4. The apparatus of claim 1 wherein the PEX conduit has an inside diameter of between approximately ½ inch to ¾ inch.

5. The apparatus of claim 1 wherein the fitting is made at least partially of brass.

6. The apparatus of claim 1 further comprising a washer placeable inside the swivel connection.

7. The apparatus of claim 6 wherein the washer is a fluid sealing washer.

8. The apparatus of claim 1 wherein the water source comprises a faucet with a male threaded garden hose connection 1 wherein the washing machine has a water input comprising a male threaded garden hose connection.

9. The apparatus of claim 1 wherein a fitting is in both opposite open ends of the conduit.

10. The apparatus of claim 1 wherein the fitting comprises a male coupling and a female coupling,(b1.1) the female coupling comprising a threaded female swivel garden hose coupling having an outer open end adapted to receive a threaded female garden hose coupling and an inner end having an opening defined in a wall across the inner end; (b1.2) the male coupling adapted for insertion into an open end of the PEX tubing and comprising a body having external surface variations adapted to bite into or resist slideable movement relative to the interior of the PEX tubing when installed and a head of a diameter larger than the largest outside diameter of the body of the male coupling and larger than the opening in the inner end of the female coupling.

11. A method of connecting a water supply to a washing machine comprising: (a) installing a female garden hose threaded swivel fitting to opposite ends of a length of cross-linked polyethylene (PEX) conduit; (b) operatively connecting the fittings to a water source and a washing machine respectively.

12. The method of claim 11 wherein the water supply comprises a male threaded garden hose connection.

13. The method of claim 11 wherein the washing machine includes a water input comprising a male threaded garden hose connection.

14. The method of claim 11 wherein the length of the PEX conduit no longer than approximately 6 feet.

15. The method of claim 11 wherein the inside diameter of the PEX conduit is between approximately ½ inch and ¾ inch.

16. The method of claim 11 further comprising operatively connecting a pair of PEX conduit and fittings according to claim 11 between hot and cold water source connections and corresponding hot and cold water inputs of a washing machine.

17. The method of claim 16 wherein the hot and cold water source connections comprise male threaded garden hose connections.

18. The method of claim of wherein the hot and cold water inputs to the washing machine comprise male threaded garden hose connections.

19. The method of claim 11 wherein the swivel fitting is made of brass.

20. The method of claim 11 further comprising using an expansion tool to expand the open end of the PEX tubing, positioning a portion of the fitting into the open end before the PEX tubing contracts, leaving the female swivel portion of the fitting exposed.

21. A method of making a removable connection between a water source and a washing machine comprising:
(a) assembling a fitting for insertion into opposite open ends of a length of cross-linked polyethylene (PEX) tubing, the assembling comprising
(a1) the fitting comprising a male coupling and a female coupling,
(a1.1) the female coupling comprising a threaded female swivel garden hose coupling having an outer open end adapted to receive a threaded female garden hose coupling and an inner end having an opening defined in a wall across the inner end;
(a1.2) the male coupling adapted for insertion into an open end of the PEX tubing and comprising a body having external surface variations adapted to bite into or resist slideable movement relative to the interior of the PEX tubing when installed and a head of a diameter larger than the largest outside diameter of the body of the male coupling and larger than the opening in the inner end of the female coupling;
(a2) seating the male coupling into the female coupling by inserting the body of the male coupling through the opening in the inner end of the female coupling;
(a3) placing a washer into the female coupling, the washer adapted to seal the junction between the head of the male coupling and the female coupling;
(b) positioning a PEX ring over an end of the PEX tubing;
(c) expanding the diameter of the end of the PEX tubing and the concentrically positioned PEX ring;
(d) prior to a substantial contraction of the PEX tubing and ring back to original diameter and shape, inserting the male coupling of the fitting into the expanded end of the PEX tubing with concentrically positioned PEX ring;
(e) allowing the PEX tubing and concentric PEX ring to contract against the male coupling.

22. The method of claim 21 further comprising installing a said fitting in the other opposite end of the PEX tubing according to the method of claim 21.

23. An washing machine system comprising: (a) a washing machine of the consumer clothes washing machine type having at least one water input connection comprising a male threaded garden hose connection; (b) a length of cross-linked polyethylene (PEX) conduit having opposite open ends and a fitting in at least one opposite end of the conduit, the fitting comprising a female garden hose threaded swivel connection, the fitting adapted for releasable connection to a water input connection on the washing machine.

24. The system of claim 23 wherein the washing machine comprises two water input connections each comprising a male threaded garden hose connection and further comprising a second conduit and fitting combination adapted for releasable connection to a water input connection on the washing machine.

25. The system of claim 24 further comprising fittings in both opposite ends of each conduit.

26. A kit for connecting a water supply to a washing machine comprising: (a) a pair of lengths of cross-linked polyethylene (PEX) conduit having opposite open ends; (b) a fitting in opposite ends of the conduit each of the pair of conduits, the fitting comprising a female garden hose threaded swivel connection.

27. The kit of claim 26 wherein the fitting is fixed to the conduit by contracting forces of the conduit relative to a portion of the fitting positioned in an end of the conduit.
